(19) United States
(12) Patent Application Publication
(10) Pub. No.: US 2014/0108099 A1
(43) Pub. Date: Apr. 17, 2014

(54) SYSTEM AND METHOD FOR BUSINESS GAMING AND OPERATIONS

(71) Applicants: Anthony Buxton, Andover, MA (US); Alexandra Buxton, Andover, MA (US)

(72) Inventors: Anthony Buxton, Andover, MA (US); Alexandra Buxton, Andover, MA (US)

(21) Appl. No.: 14/046,313

(22) Filed: Oct. 4, 2013

Related U.S. Application Data
(60) Provisional application No. 61/710,104, filed on Oct. 5, 2012.

(51) Int. Cl. G06Q 10/06

(52) U.S. Cl. CPC G06Q 10/0637
USPC 705/7.36

(57) ABSTRACT

In an embodiment, a system that may provide a user with information concerning a business opportunity and receive a response that defines goals associated with the business opportunity. The system may include decision-making information concerning the business opportunity and/or allow a definition of one or more strategies to achieve the defined goals. The system may include processing and communication facilities to create and/or execute the strategies to achieve the defined goals. The system may include provisions to convey and/or monitor instructions and/or feedback for activities that users of the system perform. The system may include a gaming system that may monitor, score, and/or communicate results to users of the system.

### RELATED APPLICATIONS

This application claims the benefit of and priority to U.S. Provisional Patent Application No.: 61/710,104, titled “System and Method for Business Operations and/or Gaming”, Attorney Docket No.: TAC12-01P, which was filed on Oct. 5, 2012, and the contents of which are incorporated herein by reference in their entirety as though fully set forth herein.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 illustrates an example of a computing device that may implement one or more techniques described herein;

FIG. 2 illustrates an example of a system that may implement one or more techniques described herein;

FIG. 3 illustrates an example of a newsfeed interface;

FIG. 4 illustrates an example of a tree interface;

FIG. 5 illustrates an example of a profile interface;

FIG. 6 illustrates an example of a compare interface;

FIG. 7 illustrates an example of a battlegram interface;

FIG. 8 illustrates another example of a news feed interface;

FIG. 9 illustrates another example of a tree interface;

FIG. 10 illustrates another example of a profile interface;

FIG. 11 illustrates an example of a profile interface with filters;

FIG. 12 illustrates another example of a profile interface with information displayed in a map area;

FIG. 13 illustrates an example block diagram of a business gaming (BG) system; and

FIG. 14 illustrates a flowchart of example acts that may be performed by a BG system.

### DETAILED DESCRIPTION

A business gaming (BG) system may implement gamification. Gaminfication may include, for example, using gaming techniques in real business. A BG system may involve a corporate ecosystem for multiple players, which may revolve around executing real life business missions against business goals and opportunities in order to win. More specifically, a BG system may allow multiple players to interact within the same corporate ecosystem. The multiple players may use the BG system to detect opportunities, explore business strategies, and become informed in an engaging environment to execute missions against goals in order to win.

A BG system may be designed to improve an efficiency of real business activities using, amongst other techniques, gaming and social techniques. The system may include, for example, a detect module providing a user with information concerning a business opportunity and receiving a response related to goals; an explore module that provides a user with decision-making information concerning the business opportunity and a allows definition of strategies to achieve the goals defined in the detect module; an execute module that provides processing and the communication facilities to create and execute the strategies and solutions to achieve the goals.

An agenda module may be used to convey and monitor instructions and feedback for activities that users of the BG system may perform in order for the BG system to operate. The BG system may monitor, score, and communicate results to users of the BG system in order to, for example, promote overall corporate performance.

The BG system may allow a user, who may be an employee of a company, to, for example, view interfaces of possible opportunities in a detect stage that may be provided by the BG system. After that user has identified possible opportunities (e.g. for selling a product to a specific company), that user may direct the BG system to enter an explore stage. Here, the user may, for example, explore the identified opportunities in more detail and designate these opportunities as strategies. Afterwards, the user may direct the BG system to enter an execution stage. In this stage the user may use the BG system to create a plan of execution to carry out various business objectives.

The detect stage, explore stage, and execution stage may be implemented in a detect module, explore module, and execution module, respectively, that may be included in the BG system. Activities that users may be required to perform may be managed by an agenda. The agenda may be integrated into the detect, explore, and execute modules. This integration may comprise a complete closed loop business management system.

The BG system may, for example, include various attributes. For example, the BG system may express workflow in various industries (e.g., manufacturing, media, retail). The BG system may, for example, contain features that builds in best practices by use of gaming techniques. The BG system may include, for example, leader board visible performance scores, badges, points, feedback and reward. The BG system may provide insight through the system indicated by a consistent graphic theme (e.g., red thread, red shield). The BG system may incorporate a concept of a blackbox which may include a data structure that may represent mathematic and/or business rules behind, for example, a business' operations.

The BG system may be designed to execute action in a marketplace to, for example, improve business. BG activities may be driven to respond to opportunities and their related causes or business drivers, otherwise referred to herein as “intelligences” (being based on the ability of the BG system to interpret information, or to facilitate the interpretation by use of automatic black box facilities (Detect) or through the user's interaction with Explore, described above.

Opportunities may be set up at a needs assessment stage. Examples of opportunities that may be set up at the assessment stage may include what are the measures of brand share by bedtime product that, if out of range, trigger an alert and what are the likely causes (opportunities, e.g. “economic” and possible solutions or strategies (e.g., sales promotion). Opportunities may respond to business goals of a business by continually measuring performance against goals (e.g. share) and loading detected opportunities (e.g. share below expected) into a newsfeed as an alert. As a result of defining likely strategies (e.g. sales promotion) to these opportunities (e.g. falling share) during in the needs assessment stage of client engagement, when an opportunity is detected, candidate solutions are loaded into a strategy part of the BG system. A detect newsfeed may also receive opportunities discovered by other users of the BG system by the use of messaging between users. When there is an “alert” a display may define a solution (e.g. sales promotion) and load these into a strategy portion of the BG system to be applied the opportunity (e.g. tools to align and deploy a sales force). The user may have the ability to choose tools, including alternatives.

Strategies may also be considered as a continual opportunity, that may require the game to be played continually. The lower the level may determine the opportunity importance level. For example, for a particular company, a crisis for a salesperson in a single account may not be a crisis for a chief executive officer (CEO) in the company.

Some examples of opportunities may include changes in the marketplace that creates opportunities to respond to (e.g., economic changes, demographic shift, changes in competition), internal opportunities (e.g., improvements in process (e.g. field force alignment), cost issue, product improvements), and opportunities to change market behavior (e.g., product, message). Opportunities may pose problems that may need to be corrected or situations that may be taken advantage of.

Opportunities may be addressed in the BG system by implementing a strategy that uses a selection of tools, for example, during an execute phase. For example, the BG system may include provisions to align territories of sale persons in response to addressing share loss. In some cases (e.g., field applications, journey planning) the BG system may determine an opportunity and tools automatically. In other cases a user may identify an opportunity during an explore stage, at which time they may select the identified opportunity, for example, from an interface, such as a graphical user interface (GUI), that may be provided by the BG system.

Other terms for opportunity may include Business Intelligence Drivers (BID), intelligences, Business Indicators (e.g., pain point conditions). Opportunities may be defined in a needs assessment stage as being issues, market conditions, internal factors that the BG system may address.

In some cases, an appropriate and/or recommended strategy (e.g. deploy a sales force) may be displayed in the GUI. The recommended strategy may be determined before the newsfeed or developed during the execute phase. The strategy may be identified based on, for example, preferences that may include best practices which may have been derived from analytic work done within the BG system on best practices. An opportunity category may be automatically determined at this point.

For example, an opportunity that may involve taking advantage of market gaps by retail network expansion may offer “New Store Opening” as a strategy.

Recommended strategies for a given opportunity may be pre-loaded in the BG system. Alternatively or in addition to, a user may have an option of selecting tools that may be used to select a given strategy and/or develop an alternative strategy. The option may be provided via a GUI that may employ, for example, a strategy wheel. The user may use the strategy wheel and its tools to develop alternative strategies or even multiple strategies to a given opportunity.

For example, a market share issue may be solved by a recommended sales deployment, or an alternative media promotion. A user may be given a choice to select one or the other, or both to develop an appropriate strategy solution.

BI Kits (Business Intelligence Kits) are information packets that contain data and reference material that may be required to develop a strategy for an opportunity. A BI Kit may present appropriate tools. A user may perform the necessary work in the strategy wheel. When the user is satisfied with the strategy, the user may send the strategy to a mission control, at which point the strategy may be considered locked.

The needs assessment stage may establish whether or not a given opportunity (e.g. “Economic downturn”) could automatically set an appropriate strategy (e.g., “sales promotion”). Alternatively, or in addition to, a user may manually choose a strategy during this stage.

An opportunity may be known at a newsfeed, set during an explore stage and or set/re-set during a strategy stage.

Provisions may be provided to send a strategy to a central area (e.g., a mission control area) for execution. If the strategy needs to be approved it may be sent to, for example, the appropriate people to approve it. It may remain in the central area as an unapproved strategy until approval, rejection, and/or being sent back for modification.

After a strategy has been formulated, locked and assigned to a responsible person, it becomes a mission. A mission may need to be approved to be deployed. A newsfeed notification to the originator of the strategy may provide a notification of an approved strategy. A mission associated with the strategy may be tracked through to completion via a mission tracker that may be provided by the BG system. Along the way, data may be collected for process improvement or other purposes.

A BG system may connect goals, strategies, and missions of a company. A mission may be tagged to an originating goal. Business processes that drive various companies may be repeatable, thus, the BG system may implement repeatable templates that may be used as a basis to customize the system for a particular company. The BG system may incorporate various decision-making capabilities (e.g., territory optimization, media buying) in one place, under a strategies section and tie them to goals. This tying may occur during a needs assessment stage.

The BG system may identify different types of goals that may be solved by the same process. For example, a first retailer's goal may be profitable site selection and a second retailer's goal may be market coverage. Both goals may be solved by the same process (e.g., a travel time model). This process may be identified by the BG system.

The BG system may identify goals that may be solved by different processes. For example, a first company and a second company may both have a goal of promotional efficiency. The BG system may determine that this goal may be achieved by the first company be by using sales people in an alignment optimization and by the second company be purchasing media.

The needs assessment stage may be used to guide a configuration of the BG system to provide a goal mechanism and a choice of strategy tools that are appropriate to a user's needs. Setting the goals and metrics (measurement points that indicate a problem, need or goal) may be dependent on each user's unique data.

Therefore a relationship between goals and strategy tools may be wired together according to results of the needs assessment stage. A result of the assessment stage may include identifying links between goals and strategies.

As will be described further below, the explore stage may include interaction with a map, that may be displayed in a GUI. There may be a fluid connection between explore elements and the map so that most actions in either displays like tables, charts, and so on may produce consequential actions on the map and vice versa.

The BG system may integrate mapping, data management, and marketing systems into a corporate workflow in various distinct stages. These stages may include a detect stage, explore stage, and execute stage. The integration may involve, for example, combining location-based analytical techniques with gaming concepts for performance measurement and engagement, and social networking within a corporation to improve communications relating to corporate goals.

The BG system may combine GIS (Geographic Information Systems), gaming, and social networking to, for example, manage a business workflow and a staging of workflow into the three stages of detect, explore, and execute.

The BG system may include multiple reporting levels within a corporation. This reporting may include, for example, (1) continual communications about marketing opportunities at a location level, such as measures of sales or market share performance and emails and chats about relevant issues, (2) location-based exploration tools that may distill information directly impacting marketing performance and interpretation as to how best to respond, such as marketing recommendations for retail sites, territory definition and media targeting, (3) tools to target, refine, budget and execute market operations including map definition, data interpretation and media buying tools as well as tools to manage and track decisions to completion. The BG system may provide field-based tools such as calendars, information collection facilities communications tools to assist in the implementation of operations.

BG system may interface with various agents. These agents may include policy makers, data support agents, system administrators, and business managers.

Policy Makers may determine goals, strategies and other business variables that will be used to configure the BG system for a company that may use the BG system (user company). Users of the BG system may include, for example, employees and associated people who may be involved in an execution of marketing activities of the company and who may monitor goals, sales management who may allocate territories, and advertising executives who may use the BG system to target media.

Data Support Agents may be employees of the user company who may provide custom company data for the BG system.

System Administrators may setup files necessary for the operation of the BG system. These files may include, but are not limited to, configuration files, data files, and databases.

Business Managers may include managers of the user company such as, for example, the CEO, Presidents, managers, and field staff. They may perform business management activities at their level of responsibilities within the company. Business Managers may be divided into three categories: C-suite, Operations, and Field.

Techniques described herein may be implemented in one or more computing devices. Examples of computing devices that may implement techniques described herein may include, but are not limited to, smart phones, tablets, ultrabooks, laptops, mainframes, servers, and desktop computers.

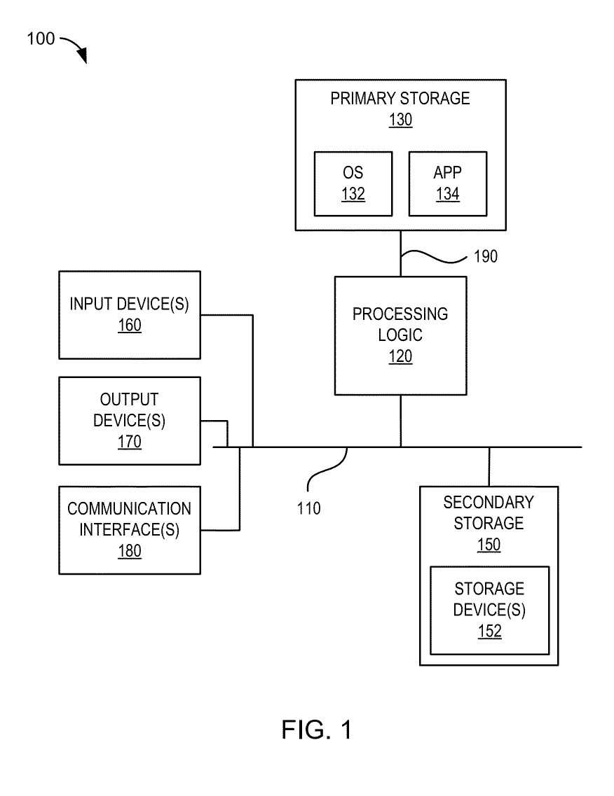

FIG. 1 illustrates a block diagram of an example of a computing device 100 that may implement one or more techniques described herein. Referring to FIG. 1, computing device 100 may include various components such as, for example, processing logic 120, primary storage 130, secondary storage 150, one or more input devices 160, one or more output devices 170, and/or one or more communication interfaces 180.

It should be noted that FIG. 1 illustrates an example embodiment of computing device 100. Other embodiments of computing device 100 may include more components or fewer components than the components illustrated in FIG. 1. Further, the components may be arranged differently than as illustrated in FIG. 1.

For example, in an embodiment of computing device 100, secondary storage 150 may be contained at a remote site that provides “cloud” storage. The site may be accessible to computing device 100 via a communications network, such as, for example, the Internet. A communication interface 180 may be used to interface the computing device 100 with the communications network.

Also, it should be noted that features provided by various components contained in other embodiments of computing device 100 may be distributed among the components differently than as described herein.

Computing device 100 may include an input/output (I/O) bus 110 that may enable communication among components in computing device 100. The components may include, for example, processing logic 120, secondary storage 150, one or more input devices 160, one or more output devices 170, and/or one or more communication interfaces 180. The communication may involve, for example, transferring control signals and/or data between the components via I/O bus 110. I/O busses that may be used to implement I/O bus 110 may include, for example, serial AT attachment (SATA), peripheral component interconnect (PCI), PCI express (PCI-e), universal serial bus (USB), small computer system interface (SCSI), serial attached SCSI (SAS), or some other I/O bus.

Computing device 100 may include a memory bus 190 that may enable information stored in primary storage 130, to be transferred between processing logic 120 and primary storage 130. The information may include, for example, computer-executable instructions and/or data that may be executed, manipulated, and/or otherwise processed by processing logic 120.

Input devices 160 may include one or more devices that may be used to input information into computing device 100. The devices may include, for example, a keyboard, computer mouse, microphone, camera, trackball, gyroscopic device (e.g., gyroscope), mini-mouse, touch pad, stylus, graphics tablet, touch screen, joystick (isotonic or isometric), pointing stick, accelerometer, palm mouse, foot mouse, puck, eyeball controlled device, finger mouse, light pen, light gun, neural device, eye tracking device, steering wheel, yoke, jog dial, space ball, directional pad, dance pad, soap mouse, haptic device, tactile device, neural device, multipoint input device, discrete pointing device, and/or some other input device.

The information may include spatial (e.g., continuous, multi-dimensional) data that may be input into computing device 100 using, for example, a pointing device, such as a computer mouse. The information may also include other forms of data, such as, for example, text that may be input using a keyboard.

Output devices 170 may include one or more devices that may output information from computing device 100. The devices may include, for example, a cathode ray tube (CRT), plasma display device, light-emitting diode (LED) display device, liquid crystal display (LCD) device, vacuum florescent display (VFD) device, surface-conduction electron-emitter display (SED) device, field emission display (FED) device, haptic device, tactile device, printer, speaker, video projector, volumetric display device, plotter, touch screen, and/or some other output device.

Output devices 170 may be directed by, for example, processing logic 120, to output the information from computing device 100. Outputting information on an output device 170 may include, for example, presenting (e.g., displaying, printing) the information on the output device 170. The information may include, for example, text, graphical user interface (GUI) elements (e.g., windows, widgets, and/or other GUI elements), audio (e.g., music, sounds), and/or other information that may be outputted by output devices 170.

Communication interfaces 180 may include logic for interfacing computing device 100 with, for example, one or more communications networks and enable computing device 100 to communicate with one or more entities (e.g., nodes) coupled to the communications networks. The communications networks may include, for example, the Internet, wide-area networks (WANs), local area networks (LANs), 3G and/or 4G (e.g., 4G long-term evolution (LTE)) networks.

Communication interfaces 180 may include one or more transceiver-like mechanisms that may enable computing device 100 to communicate with entities coupled to the communications networks. Examples of communication interfaces 180 may include a built-in network adapter, network interface card (NIC), Personal Computer Memory Card International Association (PCMCIA) network card, card bus network adapter, wireless network adapter, Universal Serial Bus (USB) network adapter, modem, and/or other device suitable for interfacing computing device 100 to a communications network.

Primary storage 130 and/or secondary storage 150 may include one or more storage modules that may contain one or more memory devices. A memory device may support, for example, serial or random access to information contained in the memory device. A memory device that supports serial access to information stored in the memory device may be referred to as a serial memory device. A memory device that supports random access to information stored in the memory device may be referred to as a random access memory (RAM) device.

A memory device may be, for example, a volatile or non-volatile memory device. A volatile memory device may be a memory device that may lose information stored in the device after power is removed from the device. A non-volatile memory device may be a memory device that may retain information stored in the device after power is removed from the device. Examples of memory devices may include dynamic RAM (DRAM) devices, flash memory devices, static RAM (SRAM) devices, zero-capacitor RAM (ZRAM) devices, twin transistor RAM (TTRAM) devices, read-only memory (ROM) devices, ferroelectric transistor RAM (FeTRAM) devices, magneto-resistive RAM (MRAM) devices, 3D cross point memory devices (e.g., phase change memory (PCM) devices), nanowire-based devices, resistive RAM (RRAM) devices, serial electrically erasable programmable ROM (SEEPROM) devices, spin transfer torque (STT) MRAM devices, and serial flash devices.

Primary storage 130 may be accessible to processing logic 120 via memory bus 190. Primary storage 130 may be a tangible non-transitory storage that may store information. The information may include computer-executable instructions and/or data that may implement operating system (OS) 132 and application (APP) 134 or parts thereof. The information may be executed, interpreted, manipulated, and/or otherwise processed by processing logic 120. Primary storage 130 may be implemented using one or more memory devices that may store the information. The memory devices may include volatile and/or non-volatile memory devices.

OS 132 may be a conventional operating system that may implement various conventional operating system functions that may include, for example, (1) scheduling one or more portions of APP 134 to run on (e.g., be executed by) the processing logic 120, (2) managing primary storage 130, and (3) controlling access to various components in computing device 100 (e.g., input devices 160, output devices 170, communication interfaces 180, secondary storage 150) and information received and/or transmitted by these components.

Examples of operating systems that may be used to implement OS 132 may include the Linux operating system, Microsoft Windows operating system, the Symbian operating system, Mac OS operating system, iOS operating system, and the Android operating system. A distribution of the Linux operating system that may be used is Red Hat Linux available from Red Hat Corporation, Raleigh, N.C. Versions of the Microsoft Windows operating system that may be used include Microsoft Windows Mobile, Microsoft Windows 8, Microsoft Windows 7, Microsoft Windows Vista, and Microsoft Windows XP operating systems available from Microsoft Inc., Redmond, Wash. The Symbian operating system is available from Accenture PLC, Dublin, Ireland. The Mac OS operating system and iOS operating system are available from Apple, Inc., Cupertino, Calif. The Android operating system is available from Google, Inc., Menlo Park, Calif.

APP 134 may be a software application that may execute under control of OS 132 on computing device 100. APP 134 and/or OS 132 may contain provisions for performing one or more techniques described herein. These provisions may be implemented using data and/or computer-executable instructions contained in APP 134 and/or OS 132. Examples of APP 134 may include client applications that may execute on a client device and server applications that may execute on a service device.

Secondary storage 150 may be a tangible non-transitory storage that may store information for computing device 100. The information may include, for example, computer-executable instructions and/or data. The information may be executed, interpreted, manipulated, and/or otherwise processed by processing logic 120.

Secondary storage may include one or more storage devices 152 that may store the information. The storage devices 152 may be accessible to processing logic 120 via I/O bus 110. The storage devices 152 may be volatile or non-volatile. Examples of storage devices 152 may include magnetic disk drives, optical disk drives, random-access memory (RAM) disk drives, flash drives, solid-state disks (SSDs), and/or hybrid drives. The information may be stored on one or more tangible non-transitory computer-readable media contained in the storage devices 152. Examples of tangible non-transitory computer-readable media that may be contained in the storage devices may include magnetic discs, optical discs, volatile memory devices, and/or non-volatile memory devices.

Processing logic 120 may include logic for interpreting, executing, and/or otherwise processing information. The information may include information that may be stored in primary storage 130 and/or secondary storage 150. In addition, the information may include information that may be acquired (e.g., read, received) by one or more input devices 160 and/or communication interfaces 180.

Processing logic 120 may include a variety of heterogeneous hardware. For example, the hardware may include some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), and/or other types of processing logic that may, for example, interpret, execute, manipulate, and/or otherwise process the information. Processing logic 120 may comprise a single core or multiple cores.

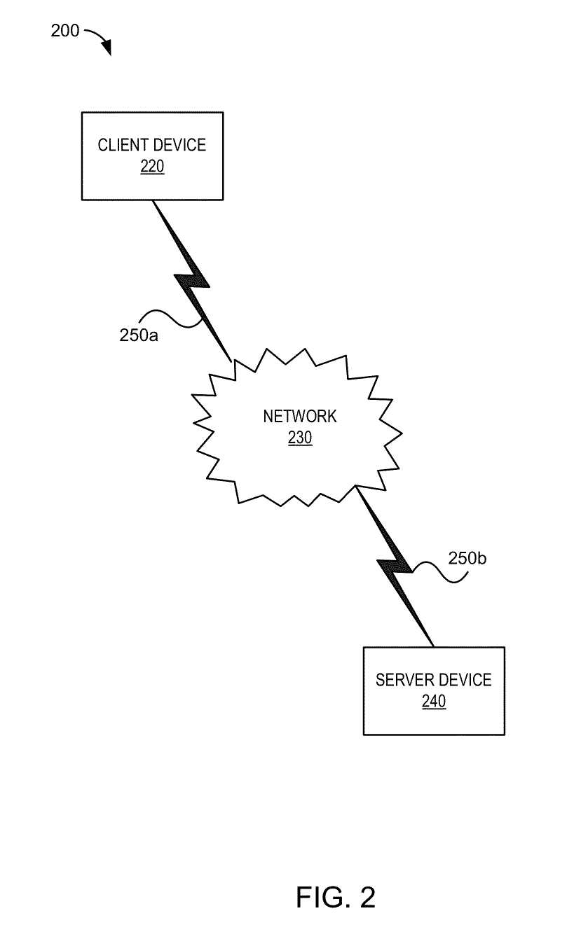

FIG. 2 illustrates an example of a system 200 that may implement one or more techniques described herein. Referring to FIG. 2, system 200 may include a client device 220, a network 230, and a server device 240. It should be noted that system 200 is an example of a system that may implement one or more techniques described herein. Systems that may be more complex or less complex than system 200 may implement one or more techniques described herein. For example, a system that may implement one or more techniques described herein may include multiple client devices 240 and/or multiple server devices 240 interconnected via one or more networks 230.

Client device 220 may include one or more computing devices, such as computing device 100. Client device 220 may communicate with server device 220 via network 230. The communication may involve, for example, exchanging information (e.g., data) via the network 230. The information may be exchanged in packets using various protocols such as, for example, the Transmission Control Protocol (TCP), Internet Protocol (IP), or some other protocol. The information may be processed by an application 134 that may be executed by client device 220. The processed information may be displayed on an output device 170 that may be included in client device 220. The interface may be displayed by an application 134 that may be executing on the client device 220. Examples of information that may be displayed on client device 200 will be discussed further below.

Server device 240 may include one or more computing devices, such as computing device 100. Server device 240 may provide (e.g., serve) information to the client device 220 via network 230. Server device 240 may also acquire information from client device 220 via network 230. Served and/or acquired information may be stored in, for example, a database and/or a file that may be contained in a secondary storage 150 associated with server device 240.

Network 230 may include a communication network that may be capable of exchanging information between the entities such as, for example, client device 220 and service device 240 in the system 200. The network 230 may include digital and/or analog aspects. The information may include machine-readable information having a format that may be adapted for use, for example, in the network 230 and/or with one or more entities in the network 230. For example, the information may be encapsulated in one or more packets that may be used to transfer the information through the network 230.

Information may be exchanged between entities using various network protocols, such as, but not limited to, the IP, Asynchronous Transfer Mode (ATM), Synchronous Optical Network (SONET), the User Datagram Protocol (UDP), TCP, Institute of Electrical and Electronics Engineers (IEEE) 802.11, etc.

The network 230 may comprise various network devices, such as gateways, routers, switches, firewalls, servers, repeaters, address translators, etc. Portions of the network 230 may be wired (e.g., using wired conductors, optical fibers, etc.) and/or wireless (e.g., using free-space optical (FSO), radio frequency (RF), acoustic transmission paths, etc.). Portions of network 230 may include a substantially open public network, such as the Internet. Portions of the network 230 may include a more restricted network, such as a private corporate network or virtual private network (VPN). It should be noted that implementations of networks and/or devices operating on networks described herein are not limited with regards to, for example, information carried by the networks, protocols used in the networks, and/or the architecture/configuration of the networks.

Implementing a BG system for the user company may involve various acts. For example, the user company's preferences may be identified. Identifying the preferences may involve holding sessions with Policy Makers of the user company to determine business goal inputs, their supporting data needs, and preferences to the configuration of BG system for their company.

Custom data for the user company may be built. This may involve building of custom company data provided by the Data Support Agents specified in the custom data preferences. System files may be set up. The system files may be used by the BG system. These files may include, for example, configuration files, data files and databases.

Detect, explore, and execute using the BG system may be performed. This may involve interacting with users of the system through a rich interface that may represent a controlled workflow driven by business goals. The BG system may enable detection and exploration of business issues, and preparation for executed missions that may be matched to business goals. The BG system may also provide the communications and feedback facilities for, for example, business management activities. These communications and feedback may be provided to, for example, business managers in the form of alerts.

The BG system may include various capabilities for various agents. For example, for Policy Makers, the BG system may include a framework within which to design their own way of doing business that can be translated into BG. This may be referred to as a needs assessment. For Data Support Agents, a configuration process and tools that link corporate data with BG may be provided. For System Administrators, may provide a toolset that facilitates granting and managing secure user access to BG, with features appropriate to the user's needs and tools to calibrate performance measures to be used in BG. For Business Managers the BG system may provide the ability to, for example, detect business issues, explore business issues, and execute business strategies.

By applying the above detect, explore, and execute sequence into a connected workflow the BG system may compartmentalize business stages. Moreover, the BG system may also present specific geographic and data management tools appropriate to each stage in the sequence. Thus, the BG system may compartmentalize activities with tools and then connect them together into a closed loop system.

The BG system may be driven by business goal inputs that, through a controlled workflow, may be detected, explored, and prepared for executed missions. The missions may be matched to goals. For example, a storyboard may include the following scenario.

An automatic data inspection alerts senior management in a first company that market share is down in a particular geographical area. A senior manager inspects details about the market in the geographical area and determines that the cause is a demographic shift combined with competitive activity and may use an explore feature of the BG system to explore and tag the area for action.

The senior manager may send this via the BG system as a strategy to a junior manager in the geographical area. The explore feature may contain a number of communication tools like email and chat that may use social network principles to keep stakeholders involved in the process of arriving at the best results. The junior manager may receive an alert from the BG system. The junior manager may use alignment tools and media targeting tools that may be provided by an execute feature of the BG system to address the problem and generate solutions to the problem. The solutions may be passed up as data packets comprising maps, data, costs and projected outcomes to a mission control feature of the BG system. The mission control feature may include provisions for providing the solutions to an agent for approval.

After the solutions are approved, sales deployment and media instructions may be sent by the BG system to appropriate managers to carry out. These activities may be monitored in a mission tracker feature that may be provided by the BG system, with detailed instructions being sent to the managers available in an agenda.

Upon Mission completion, results may be monitored and fed back into a management monitoring feature using gaming techniques which would expect to see a return on investment (ROI) for the investment in sales deployment and media targeting.

Workflow stages may include detect, explore, and execute stages. The detect stage may be presented as a newsfeed that may be organized by goals. The detect stage may push information to recipients using various communications methods such as, for example, alerts, missions, electronic mail (email), and chat. The detect stage may expect a response that carries goals through the system to execution. An objective of the detect stage may be to drive business processes along corporate goals, keeping all participants involved.

If more insight is desired, the explore stage may guide decision making and provide a means to move decisions to a strategy stage. An objective of the explore stage may be to provide insight, or intelligences which may be used to guide a user to correct strategies/solutions to achieving goals.

The execute stage may include communication facilities to create and execute strategies, execute solutions. An objective of strategy may be to make sure that the right things get done in the best way.

Feedback provided by the BG system may be used to provide a reward (gamification) whose objective may be to promote repeated use and encourage users toward company goals that if successfully conceived and executed will forge a corporate following with a common business understanding.

The BG system may include an interface (e.g., a GUI) that may be presented to a user in a sequence of steps, or workflow with communications and feedback facilities designed to increase an accuracy and speed of marketing and business management activities. Each of the elements in each step may be programmed in accordance with the user's role that may be controlled by the system's permissions feature.

In the needs assessment stage certain data associated with a user company may be identified. This information may include, for example, company name, product, location, business unit, business manager, business unit goal, business unit performance data, business unit goal strategy, business unit goal strategy intelligence, business unit goal strategy tool, business unit goal strategy approver (e.g., specific business managers or rules), business unit goal mission task (mission tasks), business unit profile data, business unit competitor data, business unit chart setting, and/or preferences (e.g., on goal calculation, red thread rules, data currency, data feed frequency).

A detect feature of the BG system focused fast, in the know, and up to date by providing a continual re-set of activities that may be specifically important to him Upon launch the detect feature may present a newsfeed facility which may display essential information and instruction. Newsfeeds may serve as an important corporate news channel, a socially focused business hub, that may involve continual inspection. The newsfeed facility include one or more inputs that the user may react to. The inputs may be presented on one or more dashboards. Elements (e.g., messages) provided by the newsfeed facility may be sorted by date, score, and/or other criteria.

A newsfeed element may be designed to invite the user to open it up and view/study a profile along with many other details (e.g., photos, surveys), after which the user may move into an executable solution. The BG system may include an interface that may enable the user to open up the newsfeed element and move into the executable solution. In the case of Missions, the user may be taken by the interface to a mission bento box with a selected mission open. A newsfeed element may be linked through the various BG stages and finally to an Executed outcome when done.

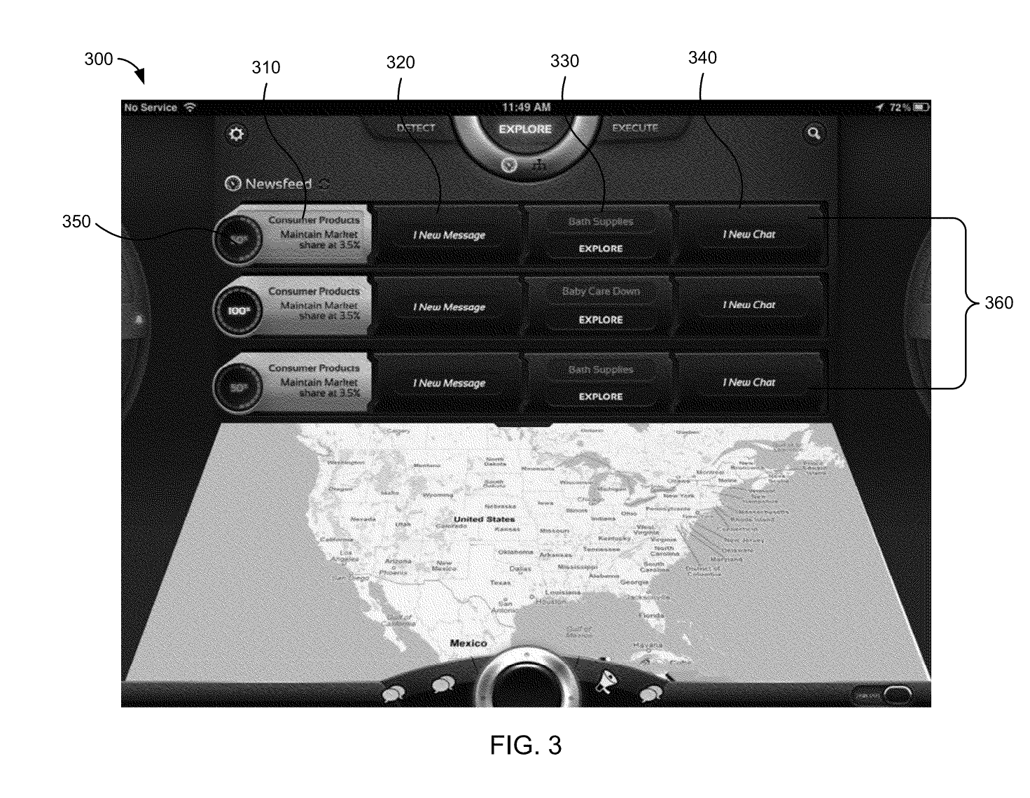

FIG. 3 illustrates an example of a newsfeed interface 300 of newsfeed information. The newsfeed interface 300 may be displayed on an output device 170 that may be associated with a computing device such as, for example, a client device 220 and/or a server device 240. The interface may be displayed by an application 134 that may be executing on the computing device.

Referring to FIG. 3, newsfeed interface 300 may include a dashboard area 360. The dashboard area may include, for example, the newsfeed information. The newsfeed information may include, for example, goal information 310 and information associated with the goal information 310. The information associated with the goal information 310 may include message information 320, product information 330, and/or chat information 340 that may be associated with goals listed in the goal information 310. The interface 300 may also include a percentage of the goal that has been achieved 350.

The goal information 310 may include a description of one or more goals that may be set, for example, by a user company for one or more business units within the user company. For example, a business unit within a user company may be named “Consumer Products”. A goal for the business unit may be to “maintain market share at 3.5% for a particular product”. The business name and the goal may be presented in interface 300, for example, in the goal information 310. The name of the product may be presented in interface 300 in the product information area 330.

The newsfeed interface 300 may include provisions to enable a user to further explore the information associated with the goal information. These provisions may include, for example, one or more GUI widgets (e.g., GUI buttons) that may be selected to drill-down into the information. For example, the message information 320 may include a GUI button that when selected may display one or more messages associated with a goal listed in the goal information 310. Similarly, chat information 340 may include a GUI button that when selected may display one or more chats associated with the goal information 310.

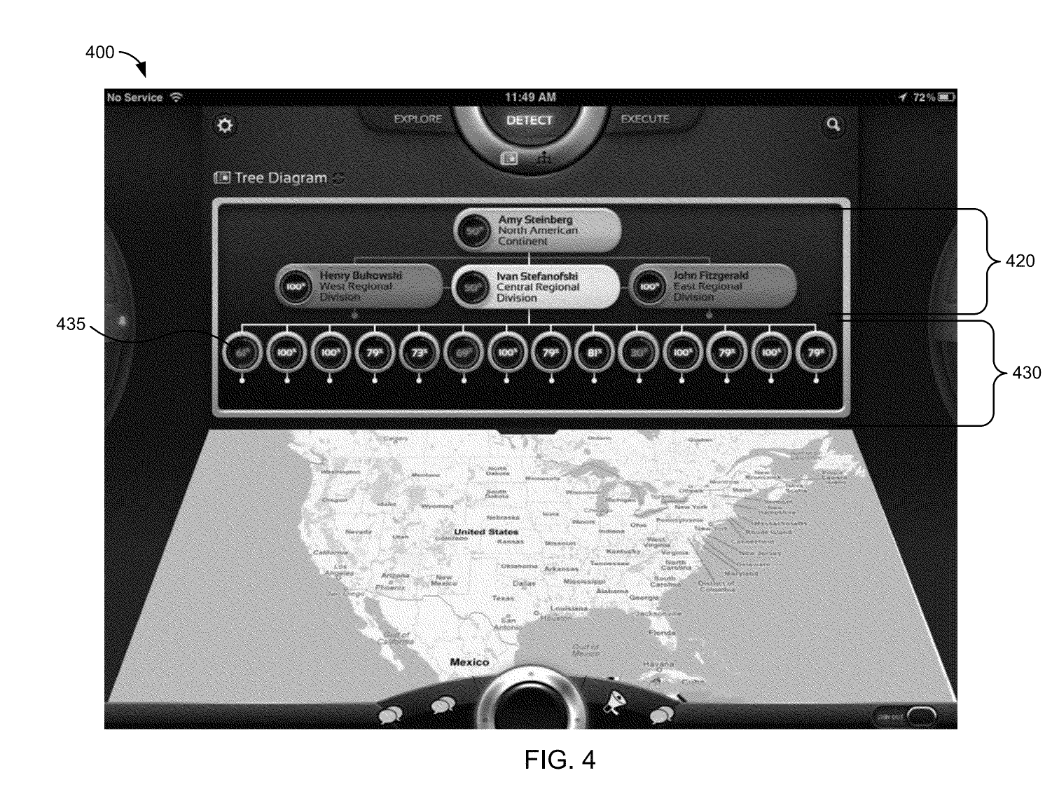

FIG. 4 illustrates an example of a tree interface 400. The tree interface 400 may provide a tree diagram of information associated with a user company. The tree interface 400 may be displayed on an output device 170 that may be associated with a computing device such as, for example, a client device 220 and/or server device 240. The interface may be displayed by an application 134 that may be executing on the computing device.

Referring to FIG. 4, the tree interface 400 may include a tree diagram 420 and an alert map 430.

The tree diagram 420 may include an organizational representation of a user company's hierarchy, connected to target spots 435 in the alert map 430. The target spots 435 may provide a visual representation of where problems are within a hierarchical structure.

The alert map 430 may display a hierarchy of locations or products allowing a user to see all parts and relationships of the hierarchy structure several levels deep with map references. Each target spot 435 of the alert map 430 may display an identifier, numerical rating, and a color.

Explore may provide information and tools to explore a business issue. Explore may be used to (1) to understand a business issue and (2) reduce an amount of information to act on.

A profile may be considered a brief. A profile may contain instructions based on goals plus as much relevant information in a variety of forms (e.g., map, tables of internal or external data, charts, photos, notes, conversations) as is possible to assemble. Everything about this location is accessible in the profile. It always pertains to a specific geography that in the case of operations people may often be the lowest or second lowest level of granularity (e.g. territory with members) and at higher management levels may include a hierarchical structure to which the user can navigate.

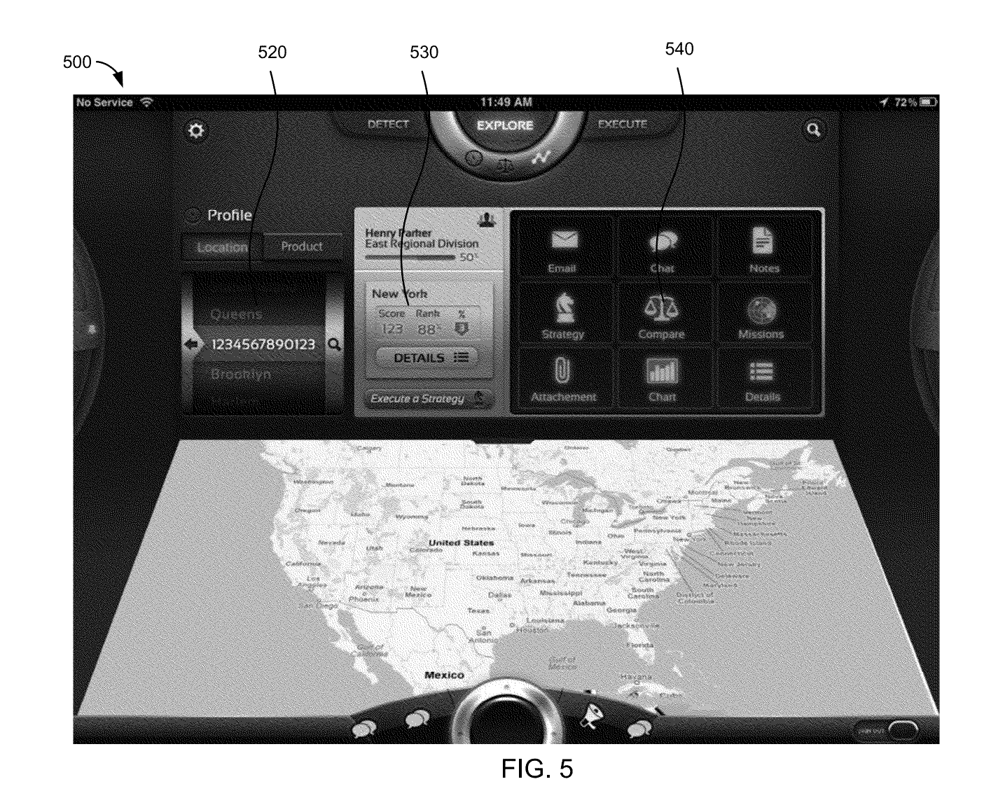

FIG. 5 illustrates an example of a profile interface 500. The profile interface 500 may be displayed on an output device 170 that may be associated with a computing device, such as, for example, a client device 220 and/or a server device 240. The interface may be displayed by an application 134 that may be executing on the computing device.

Referring to FIG. 5, the profile interface 500 may include a profiled item area 520, a profiled item information area 530, and a control dock 540. The profile item area 520 may include a plurality of profiled items. The profiled items may be organized in the profiled item area 520 as a revolving spindle that may be spun using, for example, one or more gestures such as finger movements applied to a touch screen. The profiled item area 520 may include provisions to for selecting a profiled item. The profiled item may be, for example, a geographical location and/or product.

The profiled item information area 530 may include provisions for displaying information associated with, for example, a selected profiled item. The information may include, for example, information about one or more goals (e.g., percentage of goal completeness) or other details that may be associated with the profiled item. Moreover, the profiled item information area may include provisions to execute one or more strategies that may be associated with the profiled item.

The control dock 540 may include one or more GUI widgets that may be used to view information associated with a profiled item. The profiled item may include a profiled item selected in the profiled item area 520. The information may include, for example, email messages, chat messages, notes, strategies, compare lists, missions, attachments, charts, and/or details associated with the profiled item.

Various actions may be taken based on selecting a GUI widget in the control dock 540. For example, selecting an email control dock button in the control dock 540 may display a list of email files related to the profiled item. Selecting a chat control dock GUI button in the control dock 540 may display a list of all chat files related to the profiled item. Selecting a note control dock GUI button in the control dock 540 may display a list of note files related to the profiled item. Selecting a strategy control dock GUI button in the control dock 540 may display a list of strategies related to the profiled item. Selecting a compare control dock GUI button in the control dock 540 may display a list of compare files related to the profiled item. Selecting a mission control dock GUI button in the control dock 540 may display a list of all mission files related to the profiled item. Selecting an attachment control dock GUI button in the control dock 540 may display attachment type files of the profiled item. The files may be displayed one at a time as the profiled item content. Selecting a chart control dock GUI button in the control dock 540 may display chart type files of the profiled item. The files may be displayed one at a time as the profiled item content. Selecting a details control dock GUI button in the control dock 540 may display details of pre-determined set of variables for the subject location or product in the profiled item content area.

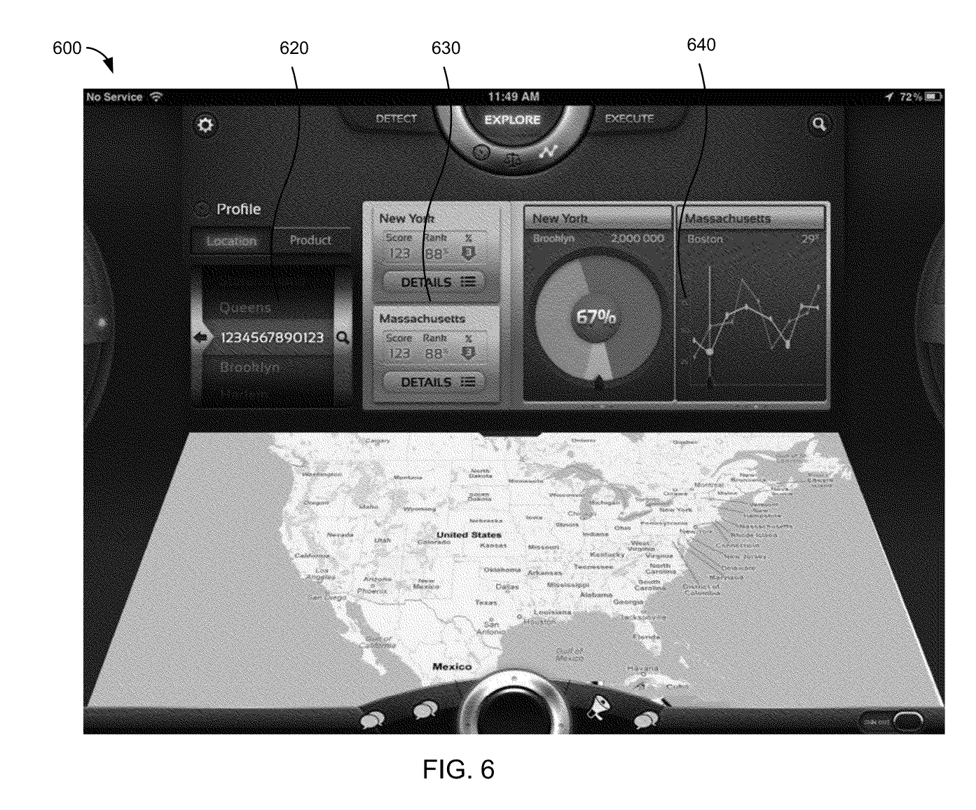

The BG system may include a facility to predict one or more outcomes by, for example, identifying similarities and/or exceptions to profiled items with issues. FIG. 6 illustrates an example of a compare interface 600 that may provide information associated with a comparison of various profiled items. The interface 600 may be displayed on an output device 170 that may be associated with a computing device such as, for example, a client device 220 and/or a server device 240. The interface may be displayed by an application 134 that may be executing on the computing device. The information may be used to, for example, identify similarities and/or exceptions to profiled items that may have issues.

Referring to FIG. 6, compare interface 600 may include a profiled item area 620, a profiled item information area 630, and chart area 640. The profiled item area 620 may include provisions for selecting a profiled item. The profiled item may be, for example, a geographical location and/or product.

The profiled item information area 630 may include provisions for displaying information associated with, for example, the selected profiled item. The information may include, for example, information about one or more goals (e.g., percentage of goal completeness) or other details that may be associated with the profiled item.

The chart area 640 may include provisions for displaying, for example, one or more graphical charts that may be associated with profiled items being compared. The charts may include, for example, line charts, pie charts, or other types of charts. The types of charts may be, for example, predetermined by an application that may be executing on the client device 220 and/or the server device 240.

The BG system may include a facility to compare profiled items (e.g., locations, products) with competitors. This facility may be referred to as a battlegram. The facility may include location selection by, for example, table and chart, profile summary response and the ability to select locations for strategic response.

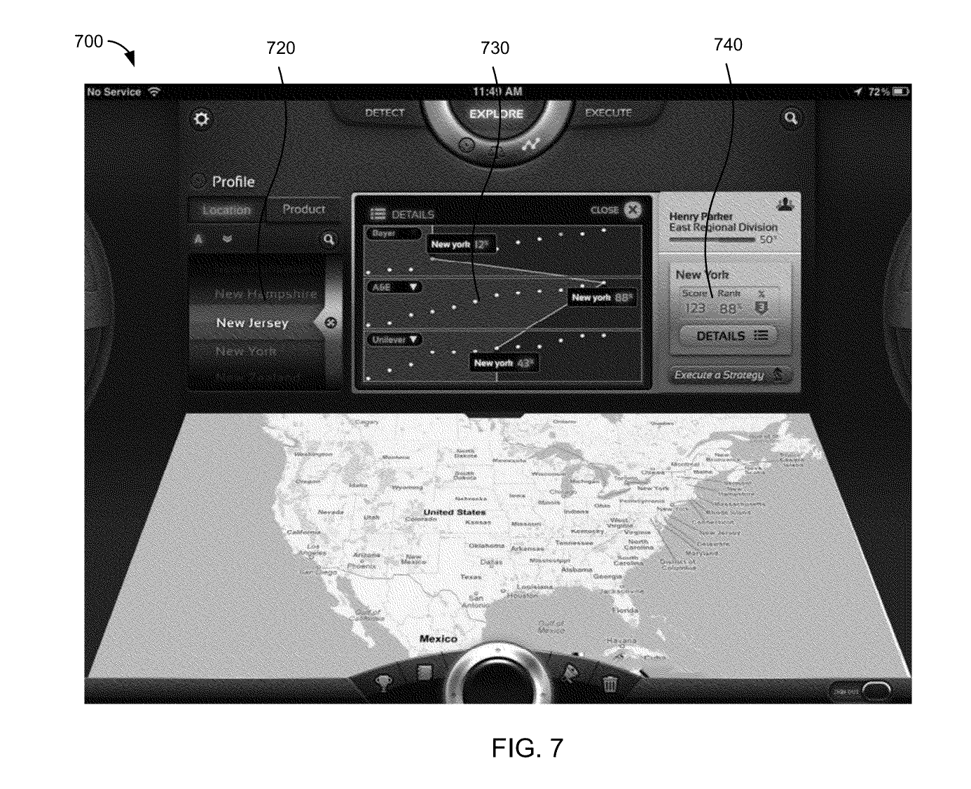

FIG. 7 illustrates an example of a battlegram interface 700 that may enable comparing profiled items with competitors of a user company. The interface 700 may be displayed on an output device 170 that may be associated with a computing device such as, for example, a client device 220 and/or a server device 240. The interface may be displayed by an application 134 that may be executing on the computing device.

Referring to FIG. 7, battlegram interface 700 may include a profiled item area 720, a profiled item chart area 730, and a profiled item information area 740. Information included in the battlegram interface 700 may be based on, for example, business units within the user company.

The profiled item area 720 may include provisions for selecting a profiled item. The profiled item may be, for example, a geographical location, a business unit, and/or product. The profiled item may be associated with the user company.

The profiled item information area 740 may include provisions for displaying information (e.g., details) associated with, for example, a selected profiled item. The information may include, for example, information about one or more goals (e.g., percentage of goal completeness) or other details that may be associated with the profiled item.

The profiled item chart area 730 may include information associated with the profiled item and/or competitor information. For example, for a given selected profiled item, the details area 730 may include information related to market share of various competitors of the user company for that selected profiled item. Information displayed in the details area 730 may be presented using, for example, graphical charts although other techniques such as, for example tables, may be used to present the information.

Charts in the profiled item chart area 730 may include, for example, chart dots where each item in the profiled item list is plotted by a chart dot, in an order of their calculated score using a selectable chart data variable. A chart dot may be color-coded based on, for example, a selectable comparison data variable, which may be presented in the profiled item chart area 730. For example, a dot may be colored a first color (e.g., red) if the corresponding profiled item has a negative comparison data variable value otherwise it may be colored a second color (e.g., black).

The chart data variable may be selected from a pre-determined list of data variables. The list of variables may be determined during a needs assessment phase for the user company. Charts displayed in the profiled item chart area 730 may be rebuilt based on the selected chart data variable.

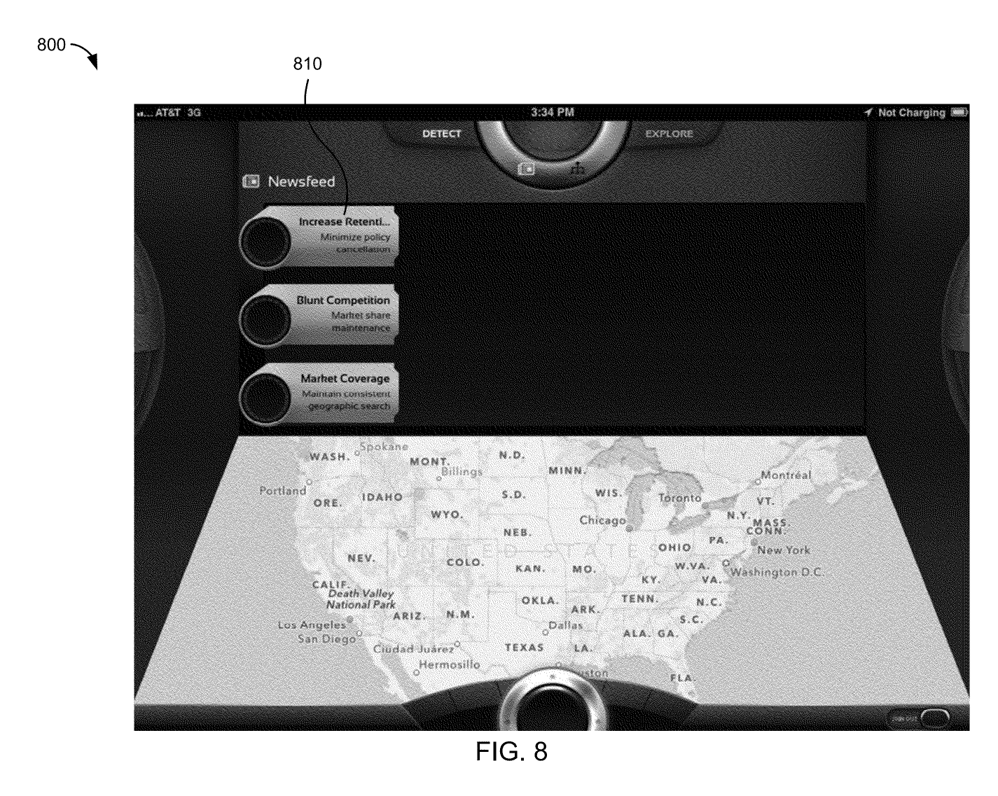

Techniques described herein may be employed to handle various business needs. For example, a user company may have needs that may involve identifying goals, identifying strategies that may be used to reach those goals, executing the strategies, and/or determining whether the strategies were successful. FIGS. 8-12 illustrate interfaces that may be used to assist in addressing the above needs.

FIG. 8 illustrates an example of a newsfeed interface 800 of newsfeed information. The newsfeed interface 800 may be displayed on an output device 170 that may be associated with a computing device such as, for example, a client device 220 and/or a server device 240. The interface may be displayed by an application 134 that may be executing on the computing device.

Referring to FIG. 8, the newsfeed information may include, for example, goal information 810. It should be noted that newsfeed interface 800 may contain other provisions. For example, newsfeed interface 800 may include information such as information associated with the goal information 810. The information associated with the goal information may include, for example, message information, chat information, or other information that may be associated with, for example, goals listed in the goal information 810 (e.g., a percentage of the goal that has been achieved).

The goal information 810 may include a description of one or more goals that may be set, for example, by a user company for one or more business units within the user company. The goals may be set in a needs assessment phase for the user company. The goal information 810 that is displayed in newsfeed interface 800 may be identified, for example, based on a user of the BG system.

For example, a user company may have a business unit that may be named “sales”. A goal for the sales business unit may be to “increase market coverage”. The goal may be identified during a needs assessment phase of the user company when assessing goals for the sales business unit. Interface 800 may display the goal to a user of the BG system who may be member of the sales business unit (e.g., a sales manager).

The newsfeed interface 800 may include provisions to enable a user to further explore the information associated with the goal information. These provisions may include, for example, one or more GUI buttons that may be selected to drill-down into the information. For example, if message information is displayed, interface 800 may include a GUI button that when selected may display one or more messages associated with a goal listed in the goal information 810.

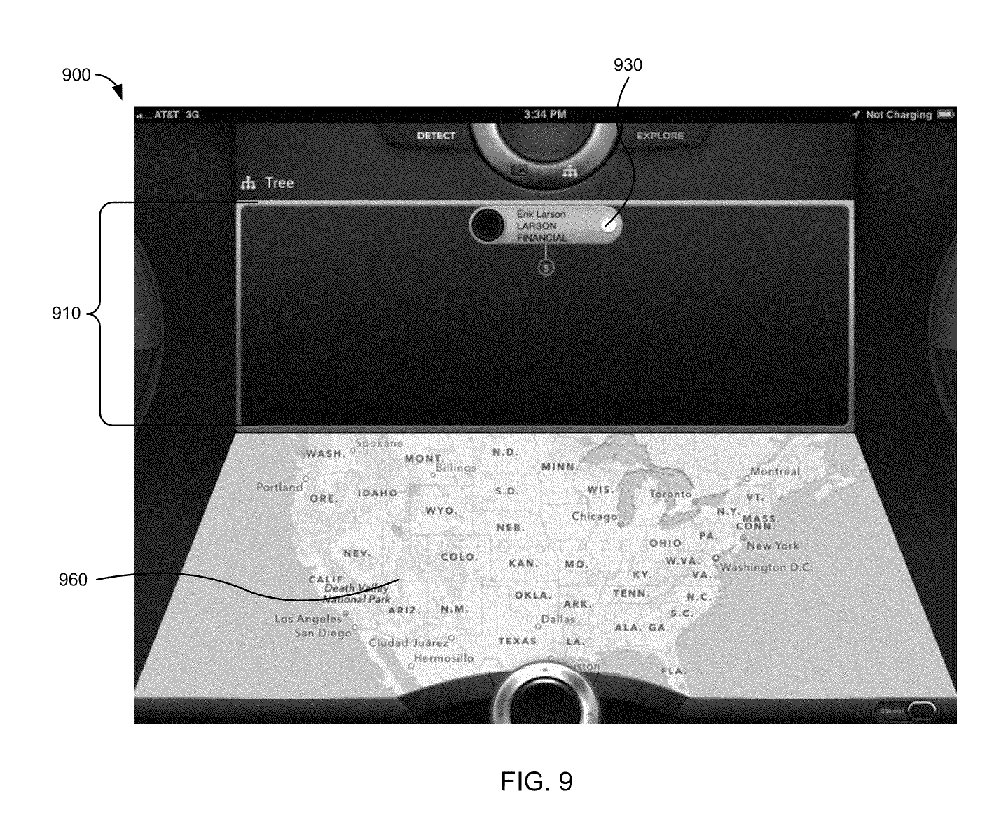

FIG. 9 illustrates an example of a tree interface 900. The tree interface 900 may provide a tree diagram of information associated with a user company. The information may include, for example, an organizational representation of the user company's hierarchy. The tree interface 900 may be displayed on an output device 170 that may be associated with a computing device such as, for example, a client device 220 and/or a server device 240. The interface may be displayed by an application 134 that may be executing on the computing device.

Referring to FIG. 9, the tree interface 900 may include a tree diagram 910 and a map area 960. It should be noted that additional information may be included in tree interface 900 such as, for example, an alert map, as described above.

The tree diagram 910 may present a representation of the user company's organizational hierarchy. Here, the tree diagram 910 may include one or more nodes 930 where a node may represent a member of an organization (e.g., business unit) within the user company. Information presented in a node 930 may include a name of the member and a name of the organization the member belongs to.

The map area 960 may be used to provide, for example, geographical information that may be related to a node in the tree diagram 910. For example, suppose node 930 represents an insurance sales agent. Selecting a middle portion of node 930 may provide an indication of a geographical location of the sales agent's office in the map area 960. Selecting a left hand portion of node 930 may provide a geographical indication of data associated with the sales agent (e.g., clients of the agent, insurance policies sold by the agent) in the map area 960.

Selecting a node in the tree diagram 910 may activate that node in the BG system. For example, selecting a middle portion of node 930 may activate node 930.

Selecting a node in tree diagram 910 may cause additional information associated with the node to be displayed in the tree diagram 910. For example, selecting node 930 may cause the tree diagram 910 to display a hierarchy of members that report to the member represented by node 930 in the tree diagram 910.

Selecting a node in tree diagram 910 may provide an activation of a next process. For example, selecting a right hand portion of node 930 may cause an activation of a next process to perform by a user.

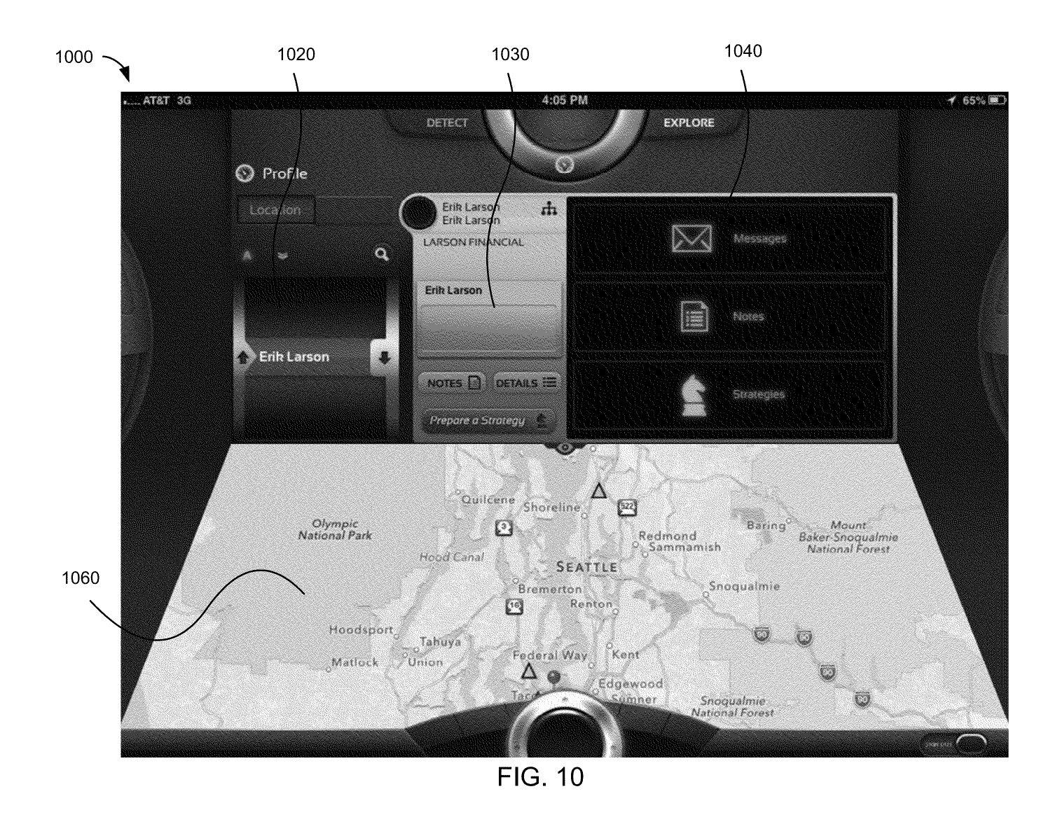

FIG. 10 illustrates an example of a profile interface 1000. The profile interface 1000 may be displayed on an output device 170 that may be associated with a computing device such as, for example, a client device 220 and/or a server device 240. The interface may be displayed by an application 134 that may be executing on the computing device.

Referring to FIG. 10, the profile interface 1000 may include a profiled item area 1020, a profiled item information area 1030, a control dock 1040, and a map area 1060. The profiled item area 1020 may include provisions for displaying and/or selecting one or more profiled items. A profiled item may include, for example, a geographical location and/or a member of a user company's organization. It should be noted, however, that other types of profiled items may be used.

The profiled item information area 1030 may include provisions for displaying information associated with, for example, a selected profiled item. The information may include, for example, information about one or more goals (e.g., percentage of goal completeness) or other details that may be associated with the profiled item, a business unit associated with the profiled item, and/or other information that may be associated with the profiled item.

The profiled item information area 1030 may include provisions to prepare one or more strategies that may be associated with the profiled item. These provisions may include, for example, a GUI button that may be selected by a user. Selecting the GUI button may cause a popup window to be displayed that may enable the user to specify a strategy. The specified strategy may be associated with a goal that may be associated with a profiled item. The specified strategy may be stored in storage (e.g., secondary storage 150) that may be provided by server device 240. The specified strategy may be presented to other members in the user company for approval. After approval is given, the specified strategy may implemented, for example, a member of the user company that may be represented by the profiled item.

The control dock 1040 may include one or more GUI buttons that may be used to view information associated with a profiled item. The profiled item may include a profiled item selected in the profiled item area 1020. The information may include, for example, email messages, chat messages, notes, strategies, compare lists, missions, attachments, charts, and/or details associated with the profiled item.

Various actions may be taken based on selecting a button in the control dock 1040. For example, selecting a messages control dock button in the control dock 1040 may display a list of emails and/or other messages (e.g., chat messages) related to the profiled item. Selecting a notes control dock button in the control dock 1040 may display a list of notes related to the profiled item. Selecting a strategy control dock button in the control dock 1040 may display a list of strategies related to the profiled item.

The map area 1060 may be used to provide, for example, geographical information related to the profiled item. For example, the profiled item may be a sales manager and the geographical information displayed in the map area 1060 may include an indication of a geographical location of the sales manager's office. Note that other information such as, for example, information related to marketing, sales, and/or other functions that may be associated with the user company may be displayed in the map area 1060.

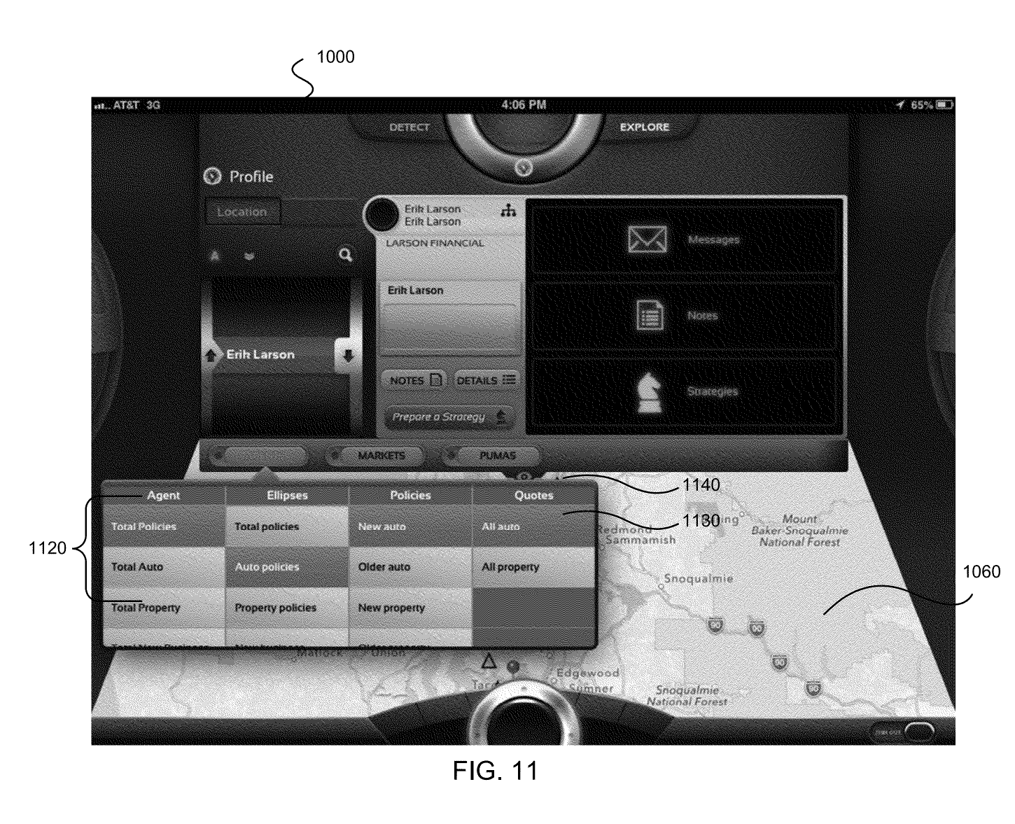

FIG. 11 illustrates an example of a filter selector 1120 that may be provided by the profile interface 1000. Referring to FIG. 11, the filter selector 1120 may be displayed in response to a user indication (e.g., pressing a GUI button on interface 1000).

The filter selector 1120 may enable the user to select various filters 1130 that may be applied to information associated with the profiled item. The filter selector 1120 may include one or more categories 1140 that may, for example, relate to the data. The filtered information may be graphically displayed in the map area 1060.

For example, filter selector 1120 may include an “Agent” category 1140 that may identify, for example, data associated with sales agents. Filters 1130 that may be applied to the data may include, for example, total policies, total auto policies, total property policies, and so on. As will be described further below, the map area 1060 may graphically display the filtered data.

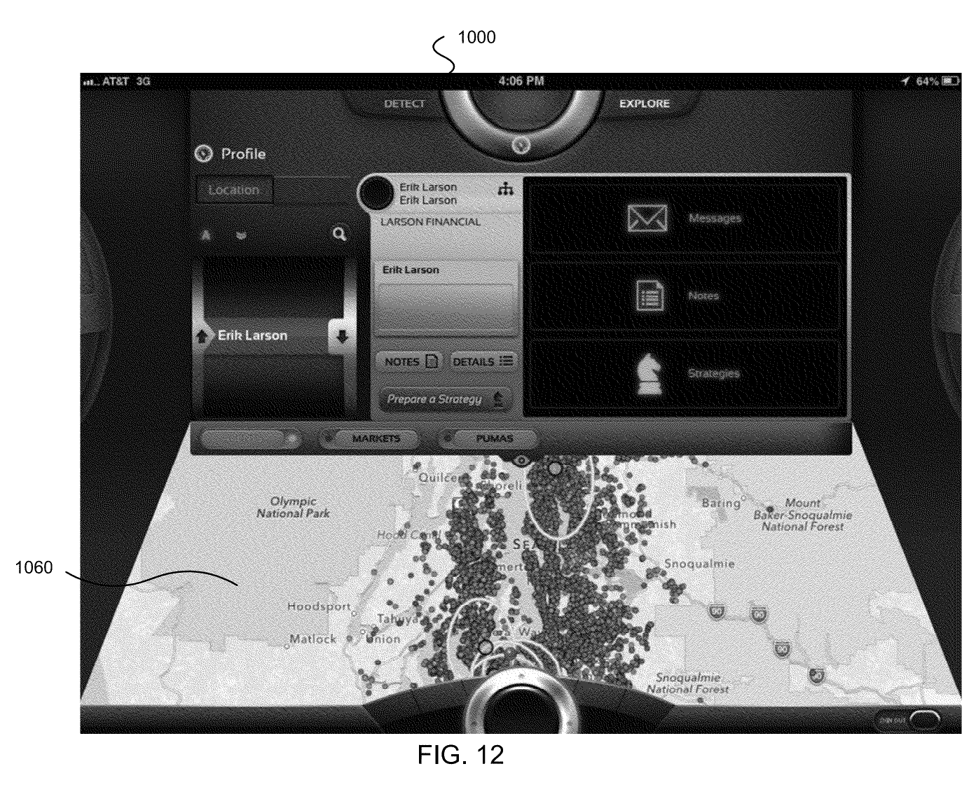

FIG. 12 illustrates an example of a profile interface 1000 with information displayed in the map area 1060. The information may include filtered data that may be graphically displayed in the map area 1060.

For example, referring to FIGS. 1, 2, 11, and 12 suppose a user wishes to have the BG system graphically display certain agent information associated with a particular agent in the map area 1060. The user may direct a client device 220 to select one or more filters 1130 in the filter selector 1120. Suppose that the user selects a “total policies” filter 1130 under an “agent” category 1140, an “auto policies” filter 1130 under an ellipses category 1140, a “new auto” filter 1130 under a “policies” category 1140, and an “all property” filter 1130 under a “quotes” category 1140.

The client device 220 may transfer the filter selections via network 230 to server device 240. An APP 134 at the server device 240 may receive the filter selections and read the information from a second storage 150 associated with the server device 240. The APP 134 at the server device 240 may apply the selected filters to the data to generate filtered data. The server device 240 may transfer the filtered data via network 230 to the client device 220. An APP 134 at the client device 220 may receive the filtered data and process it. The APP 134 at the client device 220 may graphically display the filtered data in the map area 1060.

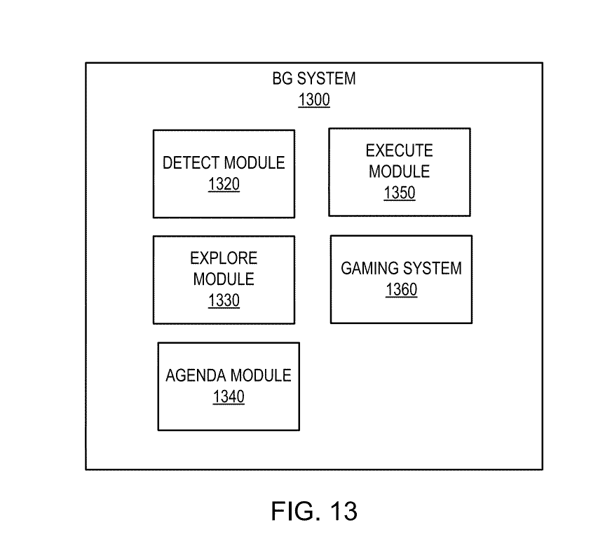

FIG. 13 illustrates an example block diagram of a business gaming (BG) system 1300. Referring to FIG. 13, BG system 1300 may include a detect module 1320, an explore module 1330, an agenda module 1340, an execute module 1350, and/or a gaming system 1360.

The detect module 1320 may provide a user with information concerning a business opportunity and receiving a response that defines goals. The explore module 1330 may provide a user with decision-making information concerning the business opportunity and/or allow definition of strategies to achieve the goals defined in the detect module 1320. The execute module 1350 may provide processing and the communication facilities to create and execute the strategies and solutions to achieve the goals. The agenda module 1340 may convey and/or monitor instructions and/or feedback for activities that users of the BG system 1300 may perform. The gaming system 1360 may monitor, score, and/or communicate results to users of the system in order to promote overall corporate performance.

The detect module 1320 may be used to get a user focused fast, in the know, and up to date by providing a continual re-set of activities that are specifically important to him The detect module may include a newsfeed facility. Upon launch of the detect module 1320, the newsfeed facility may present a newsfeed format to display essential information and instruction.

Newsfeeds may serve as an essential corporate news channel, a socially focused business hub, that may involve continual inspection. The newsfeed facility may be an entry point for a user in the BG system 1300. The newsfeed facility may contain one or more inputs the user may react to presented on one or more interfaces. Newsfeed elements may be sorted by date, score or other sort criteria.

A newsfeed story may be designed to invite the user to open it up and view/study a profile along with many other details (e.g., photos, surveys), after which the user may move into an executable solution that may be provided by the execute module 1330. In the case of missions, the user may be taken past exploring to an execute provision that may be provided by the execute module, and directly to a mission bento box with a selected mission open.

A newsfeed story may be linked through the various stages that may be implemented by the BG system 1300 and finally to an executed outcome when done.

The detect module 1320 may provide a user with his business unit information that includes goals, performances, strategies, missions and communications for which the user may be able to react.

The Newsfeed may be used by the BG system 1300 to present alerts and other communications to the user.

The user may start up an application, such as APP 134, on a client device 220. The application may display a sign in screen that the user may use to sign into the BG system 1300. After logging in, interface 300 (FIG. 3) may be displayed to the user on the client device 220. The interface 300 may include business information displayed in a newsfeed style layout, such as illustrated in FIG. 3.

The user may respond to various alerts. The alerts may include business alerts, mission alerts, business strategy approval alerts, email alerts, chat alerts, and/or some other form of alert. An indication of the alerts may be displayed in, for example, dashboard area 360. The alerts may be included, for example, in one or more messages and/or chats that may be stored by the BG system 1300.

The user may respond to one or more of the alerts. Responding to an alert may involve taking an action (e.g., defining/executing a strategy, approving a strategy, reading an email, responding to a chat). The action may be taken through one or more interfaces provided by the BG system 1300. An alert may be removed after the action is taken.

The explore module 1330 may provide information and/or tools to explore a business issue. The objectives of explore module 1330 may be used by a user to understand a business issue and/or reduce an amount of information to act on. Given this, a user may proceed to the execution portions of the BG system 1300.

The explore module 1330 may be used by a user to explore, “where” and/or “who” and often a direction on “what” to do next. The explore module 1330 may incorporate, for example, rotating spindles as a map and hierarchical navigation tools together with access to a broad range of information and game-like performance measurements. In addition, the explore module 1330 may incorporate selecting location-based business elements for further strategic action within a single system workflow.

Examples of interfaces that may be provided by the explore module 1330 may include interfaces 500, 600, and 700 described above in FIGS. 5, 6, and 7, respectively.

Missions may start in strategy and go through a mission control to get executed and all may be tracked in a mission tracker. These features may be implemented, for example, by the execute module 1340. Moreover, the execute module 1340 may map processes to a connected development of solutions as in a BG strategy.

Strategy may be used to respond, with the most appropriate action (e.g., using a tool) required to meet business goals, based on opportunities (e.g., insight, intelligences) that may be derived from the detect module 1320 (e.g., newsfeed) and/or explore module 1330 (e.g., from exploring). Strategy may involve identifying an issue to be dealt with, identifying a reason for the issue (intelligence) and using tools, techniques, tactics, to resolve the issue.

For example, if market share is below budget, the explore module 1330 may be used to shed insight on the fact that low share can be corrected by, for example, a media promotion tool, as opposed to a pricing tool, or perhaps a combination. The explore module 1340 may provide a variety of solutions and may highlight a most appropriate solution. The solution may be executed by the strategies module 1340.

The agenda module 1340 may convey and/or monitor instructions and/or feedback for activities that users of the BG system 1300 may perform. Agenda module may be used to execute operations. The operations may involve operations a particular user may have to execute. The agenda module 1340 may facilitate the execution by providing the necessary tools (e.g. a journey planner, a photo-taker).

The agenda module 1340 may integrate location-based field-management tools including journey planning, data collection and reporting. The agenda module 1340 may provide the user with directives and tools to carry out operations assigned to him Specifically, the agenda module 1340 may provide a personal efficiency tool to: (a) manage work, through presentation of information (e.g. calendars, directives notes and productivity tools like a journey planner) along with the use of communications and feedback capabilities and (b) carry out tasks through provision of appropriate tools (e.g., information gathering devices like cameras, scanners, surveys, information feedback systems).

The agenda module 1340 may also provide information inputs to execute activities more efficiently due to better local information on markets, prospects, and/or accounts. The agenda module 1340 may leverages field data collection capability by using the mobile device as a sensor to improve corporate information for planning and best practices.

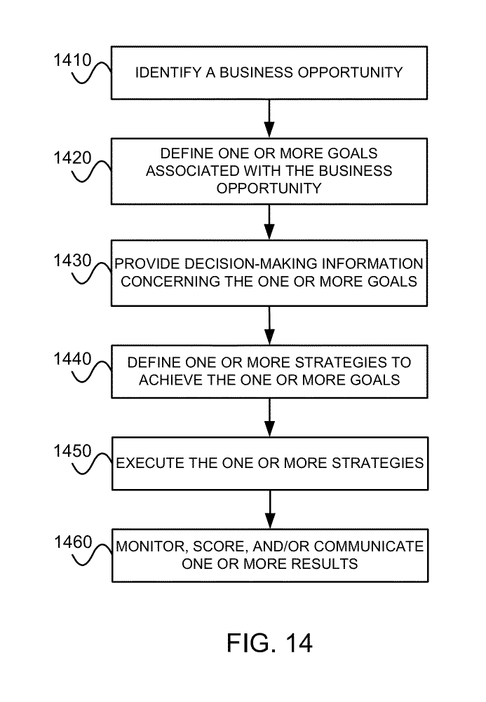

FIG. 14 illustrates a flowchart of example acts that may be performed by a BG system. Referring to FIG. 14, at block 1410, a business opportunity may be identified. For example, an employee and/or a business unit of a user company may identify a business opportunity for the user company. The business opportunity may include, for example, a market that have not been entered by the user company, a product produced within the user company that has not been marketed, and/or some other business opportunity.

At block 1420, a one or more goals associated with the identified business opportunity may be defined. For example, after the business opportunity is identified, a manager within the user company may produce a definition of (e.g., define) one or more goals associated with the business opportunity. These goals may be defined using an interface such as, for example, a GUI interface that may be associated with a computing device such as, for example, client device 220 (FIG. 2) and/or server device 240. The definition of the one or more goals may be received by the computing device and stored in a storage that may be associated with the computing device such as, for example, storage 150 (FIG. 1).

In an embodiment, the defined goals may be received by server device 240. Server device 240 may store the defined goals in a database that may be contained in a secondary storage 150 associated with the server device 240.

At block 1430, decision-making information concerning the one or more goals may be received. The decision-making information may include, for example, whether one or more of the goals have been accepted. The decision-making information may be received by a computing device.

For example, after the goals are defined, the goals may be subject to an approval process. The approval process may involve, for example, review and/or acceptance of the goals by various sources (e.g., management). The review and/or acceptance may be accommodated using a computing device such as, for example, client device 220 and/or server device 240. For acceptance, client device 220 and/or service device 240 may receive an indication (e.g., data) that may indicate one or more of the goals have been accepted.

At block 1440 one or more strategies to achieve the one or more goals may be defined. For example, an employee at the user company (e.g., a manager) may review approved goals and using a computing device such as, for example, client device 220 and/or server device 240, produce a definition of one or more strategies that may be used to achieve the goals. The employee may make use of data that may be provided by the computing device to define the strategies.

In an embodiment, interface 1000 (FIG. 10) may be displayed on an output device 170 associated with the computing device. The employee may select a “prepare a strategy” GUI button in the interface 1000. The computing device may receive the selection and display a pop-up window that may be used by the computing device to acquire the strategy. The pop up window may enable the employee to enter information that may be define a strategy. The computing device may acquire (e.g., receive) the entered information and may be store the information in a storage associated with the computing device.

The defined strategies may be received by a server device 240. The defined strategies may be sent, for example, by a client device 220 to the server device 240 via network 230. The server device 240 may store the received strategies in a storage associated with the server device 240 such as, for example, storage 150.

The defined strategies may be subject to an approval process. The approval process may include accessing the defined strategies on the server device 240 using an interface that may be provided by a client device 220. The interface may include provisions for tagging strategies that have been approved using the interface. For a particular strategy, the server device 240 may store information that may indicate whether the strategy has been approved in the storage associated with the server device 240.

At block 1450, one or more of the defined strategies may executed. For example, interface 500 (FIG. 5) may be displayed to an employee of the user company on a computing device such as, for example, client device 220 and/or server device 240. The employee may explore defined strategies and select one or more of the defined strategies to execute. The strategies may be explored and/or selected, for example, by using the “strategy” GUI button in the control dock 540. The computing device may receive an indication of the selected strategies. After selecting the strategies to execute, the employee may select (e.g., press) the “execute a strategy” GUI button in the profiled item information area 530 to execute the selected strategies. The computing device may (1) receive an indication that the “execute a strategy” GUI button has been selected and (2) in response to receiving the indication that the “execute a strategy” GUI button has been selected, execute the selected strategies.

Executing the one or more strategies may include conveying and/or monitoring instructions and/or feedback for one or more activities associated with executing the one or more strategies. For example, an employee of the user company that may be responsible for executing a particular strategy may receive instructions on how to execute the strategy from a superior. The instructions may be provided, for example, via email and/or chats that may be viewed the control dock 540. Moreover, the employee may provide feedback and/or status updates via chats and/or emails using the control dock 540. The instructions and/or feedback may be received and/or stored by a computing device such as, for example, client device 220 and/or server device 240. Alternatively or in addition to, execution of the one or more strategies may be monitored and data that may be associated with the execution may be collected. This data may be received and/or stored by the computing device.

At block 1460, one or more results associated with executing the one or more strategies may be monitored, scored, and/or communicated. For example, various reports may be generated based on information collected during the execution of the one or more strategies. The reports may be provided to various employees within the user company.

For example, profiled item information area 630 (FIG. 6) may provide (e.g., display) a scoring and rank information that may be associated with a profiled time that may be associated with results an executed strategy. The scoring information may include, for example, a score that may indicate a degree of success associated with the execution of the one or more strategies.

Moreover, chart area 640 may provide graphical information associated with results an executed strategy. Note that other ways of monitoring, scoring, and/or communicating results associated with executing the one or more strategies may be used.

The following example scenario may be helpful in understanding the above. Suppose, for example, that an automatic data inspection of sales and/or marketing data associated with a user company is performed by a BG system 1300 executing on server device 240. In response to one or more problems that may be detected during the data inspection, the BG system 1300 may generate one or more alerts. The generated alerts may be provided by the server device 240 to one or more client devices 220 associated with senior management in the user company. Suppose that the alerts indicate that market share is down in a particular geographical area.

A senior manager in the user company may use a client device 220 to inspect details about the market covered by the geographical area and determine that the cause is a demographic shift combined with competitive activity. The senior manager may use interface 1000 (FIG. 10) on the client device 220 to explore and tag the geographical area for action.

The BG system 1300 on the server device 240 may receive the tagging information and store it in a storage such as, for example, storage 150. The senior manager may create a strategy using, for example, interface 1000 on his client device 220. The created strategy may be stored by the BG system 1300 on the server device 240. The senior manager may use interface 1000 on his client device 220 to direct the BG system 1300 on the server device 240 to send the created strategy to a sales manager in the geographical area.

The sales manager may receive an alert on his client device 220. The alert may alert the sales manager to the created strategy. The sales manager may views the strategy using his client device 200, such as described above. The sales manager may execute the strategy. Executing the strategy may involve using solutions that may be provided by sales alignment tools and media targeting tools that are used to address the problem. These solutions may be passed up as data packets that may include maps, data, costs, and projected outcomes to the BG system 1300 on the server device 240 where they may go through an approval stage.

After being approved sales deployment and media instructions may be sent to the appropriate managers to carry out. These instructions may be sent by the BG system 1300 on the server device 240 to one or more client devices 220 that may be used by the managers. Activities associated with the instructions may be monitored by a mission tracker that is implemented by the BG system 1300 on the server device 240.

At mission completion, results may be acquired and monitored by the BG system 1300 on the server device 240. The results may include information (e.g., scores) that may indicate a degree of success associated with the execution of the one or more strategies. These results may be fed back, by the BG system 1300 on the server device 240, into management monitoring that may be implemented by the BG system 1300 using gaming techniques that may also be implemented by the BG system 1300. The management monitoring may expect to see a return on investment for the investment in sales deployment and media targeting.

The foregoing description of embodiments is intended to provide illustration and description, but is not intended to be exhaustive or to limit the invention to the precise form disclosed. Modifications and variations are possible in light of the above teachings or may be acquired from practice of the invention. For example, while a series of acts may be described above, the order of the acts may be modified in other implementations. Further, non-dependent acts may be performed in parallel.

Also, the term “user”, as used herein, is intended to be broadly interpreted to include, for example, a computing device (e.g., fixed computing device, mobile computing device) or a user of a computing device, unless otherwise stated.

It will be apparent that one or more embodiments, described herein, may be implemented in many different forms of software and/or hardware. Software code and/or specialized hardware used to implement embodiments described herein is not limiting of the invention. Thus, the operation and behavior of embodiments were described without reference to the specific software code and/or specialized hardware—it being understood that one would be able to design software and/or hardware to implement the embodiments based on the description herein.

Further, certain features of the invention may be implemented using computer-executable instructions that may be executed by processing logic, such as, for example, processing logic 120 that may be contained in a computing device such as, for example, client device 220 and/or service device 240. The computer-executable instructions may be stored on one or more non-transitory tangible computer-readable storage media. The media may be volatile or non-volatile and may include, for example, dynamic random access memory (DRAM), static random access memory (DRAM), flash memory, removable disks, non-removable disks, and so on.

No element, act, or instruction used herein should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It is intended that the invention not be limited to the particular embodiments disclosed above, but that the invention will include any and all particular embodiments and equivalents falling within the scope of the following appended claims.

What is claimed is:

1. A method comprising:
receiving a definition of one or more goals associated with the business opportunity;
receiving a definition of one or more strategies to achieve the one or more goals;
receiving an indication to execute one or more of the strategies;
in response to receiving the indication, executing one or more of the strategies; and
displaying information that indicates a degree of success associated with the execution of the one or more strategies.

2. The method of claim 1 further comprising:
displaying an interface on an output device to acquire the definition of the one or more goals.

3. The method of claim 2, wherein the output device is associated with a client device.

4. The method of claim 1, wherein the one or more goals are received by a server device, and wherein the method includes:
storing the one or more goals in a storage associated with the server device.

5. The method of claim 4, wherein the one or more goals are stored in a database contained in the storage associated with the server device.

6. The method of claim 1, further comprising:
displaying an interface on an output device to acquire the definition of the one or more strategies.

7. The method of claim 6, wherein the output device is associated with a client device.

8. The method of claim 1, further comprising:
displaying an interface on an output device, the interface including a graphical user interface (GUI) widget;
receiving an indication that the GUI widget has been selected; and
generating the indication to execute the one or more strategies in response to receiving the indication that the GUI widget has been selected.

9. The method of claim 8, wherein the output device is associated with a client device and wherein the interface is displayed by an application executing on the client device.

10. The method of claim 1, wherein the information that indicates a degree of success associated with the execution of the one or more strategies includes a score that represents the degree of success.

11. A non-transitory tangible computer readable medium storing one or more computer-executable instructions that when executed by processing logic cause the processing logic to:
receive a definition of one or more goals associated with the business opportunity;
receive a definition of one or more strategies to achieve the one or more goals;
receive an indication to execute one or more of the strategies;
execute one or more of the strategies; and
display information that indicates a degree of success associated with the execution of the one or more strategies.

12. The medium of claim 11 further stores one or more computer executable instructions for:
displaying an interface on an output device to acquire the definition of the one or more goals.

13. The medium of claim 11, wherein the one or more goals are received by a server device, and wherein the medium further stores one or more computer executable instructions for:
storing the one or more goals in a storage associated with the server device.

14. The medium of claim 11, wherein the medium further stores one or more computer executable instructions for:
displaying an interface on an output device to acquire the definition of the one or more strategies.

15. The medium of claim 11, wherein the medium further stores one or more computer executable instructions for:
displaying an interface on an output device, the interface including a graphical user interface (GUI) widget;
receiving an indication that the GUI widget has been selected; and
generating the indication to execute the one or more strategies in response to receiving the indication that the GUI widget has been selected.

16. An apparatus comprising:
an output device; and
processing logic for:
receiving a definition of one or more goals associated with the business opportunity,
receiving a definition of one or more strategies to achieve the one or more goals,
receiving an indication to execute one or more of the strategies,
in response to receiving the indication, executing one or more of the strategies, and
displaying information one the output device that indicates a degree of success associated with the execution of the one or more strategies.

17. The apparatus of claim 16, wherein the processing logic further:
displays an interface on the output device, the interface for acquiring the definition of the one or more goals.

18. The apparatus of claim 16, wherein the processing logic further:
displays an interface on the output device, the interface for acquiring the definition of the one or more strategies.

19. The apparatus of claim 16, wherein the processing logic further:
displays an interface on an output device, the interface including a graphical user interface (GUI) widget;
receives an indication that the GUI widget has been selected; and
generates the indication to execute the one or more strategies in response to receiving the indication that the GUI widget has been selected.

20. The apparatus of claim 16, wherein the information that indicates a degree of success associated with the execution of the one or more strategies includes a score that represents the degree of success.
